(19) United States
(12) Patent Application Publication
(10) Pub. No.: US 2011/0285679 A1
(43) Pub. Date: Nov. 24, 2011

(54) CHIP-ON-GLASS TYPE LIQUID CRYSTAL DISPLAY DEVICE

(75) Inventors: Kwang-Il OH, Daejeon-si (KR); Jun-Ho KIM, Daejeon-si (KR); Jung-Hwan CHOI, Daejeon-si (KR)

(73) Assignee: SILICON WORKS CO., LTD., Daejeon-si (KR)

(21) Appl. No.: 12/795,388

(22) Filed: Jun. 7, 2010

(30) Foreign Application Priority Data
May 18, 2010 (KR) 10-2010-0046582

(51) Int. Cl. G06F 3/038

(52) U.S. Cl. 345/206

(57) ABSTRACT

A chip-on-glass (COG) type liquid crystal display device minimizes a reflected wave from an input terminal of a source driver IC, regardless of the resistance value of a transmission line on a glass substrate, through the use of impedance matching at a front terminal of an LOG and impedance matching at an output terminal of a timing controller, thereby enhancing the frequency characteristic while maintaining a slim and lightweight design, so that it is possible to express a high-resolution high-quality image.

### BACKGROUND OF THE INVENTION

1. Field of the Invention

The present invention relates to a liquid crystal display device, and more particularly, to a chip-on-glass (COG) type liquid crystal display device which minimizes a reflected wave from an input terminal of a source driver IC, regardless of the resistance value of a transmission line on a glass substrate, through the use of timing controller impedance matching and impedance matching at a front terminal of an LOG, thereby enhancing the frequency characteristic while maintaining a slim and lightweight design, so that it is possible to express a high-resolution high-quality image.

2. Description of the Related Art

In order to drive the row lines and column lines of a liquid crystal display (LCD) panel, source driver ICs and gate driver ICs are provided on the periphery of the panel. The gate driver ICs function to select picture elements to transmit image data, and actual image data and clock signals for picture elements are provided from the source driver ICs. Generally, image data DATA and clock signals CLKs are transmitted in a multi-drop manner to the source driver ICs from a timing controller mounted on a printed circuit board (hereinafter, referred to as a “PCB”).

Data transmitted in the form of differential signals through one transmission line pair is provided in such a manner that a transmission unit generates push-pull differential signals corresponding to the data, converts the differential signals into differential voltage signals in an adjacent PCB, and then transmits the differential voltage signals to a reception unit.

FIG. 1 is a view showing an example of a conventional liquid crystal display device, and FIG. 2 is a view showing an equivalent model of the conventional liquid crystal display device shown in FIG. 1.

Referring to FIGS. 1 and 2, a liquid crystal display device 100 using LCD includes a PCB 110, a liquid crystal panel 120, a flexible printed circuit (FPC) 130, source driver ICs 131, and gate driver ICs 132.

The PCB 110 includes a termination resistor 112 and a timing controller 111 to supply image data and clock signals to the source driver ICs 131.

The liquid crystal panel 120 includes a plurality of picture elements which use the electrical characteristic of liquid crystal, wherein the respective picture elements are driven by the source driver ICs 131 and gate driver ICs 132.

Image data and clock signals in the form of differential current, which are output from the timing controller 111, are converted into a differential voltage signal through both terminals of the termination resistor 112, and the converted differential voltage signal is transmitted to corresponding source driver ICs 131 in a multi-drop manner.

Signal transmission between the PCB 110 and the source driver ICs 131 and between the source driver ICs 131 and the liquid crystal panel 120 is achieved using a tape or film, such as the FPC 130, of which the impedance component is very small.

Meanwhile, according to the user's request for liquid crystal display devices which are thin and light as well as requiring a low fabrication cost, a chip-on-glass (hereinafter, referred to as “COG”) method of adhering source driver ICs and gate driver ICs on a glass substrate, on which a panel is mounted, and using the source driver ICs and gate driver ICs has been proposed.

When a liquid crystal display device is implemented through the use of the COG manner, a liquid crystal panel, source driver ICs, and gate driver ICs must be adhered on a glass substrate. In this case, the conventional signal transmission/reception between a PCB and the source driver ICs, between the source driver ICs and the panel, and between the gate driver ICs and the panel are achieved through the use of a transmission line (i.e. Line On Glass (LOG)) mounted on the glass substrate.

The conventional liquid crystal display device shown in FIG. 1 transmits/receives signals through the transmission lines on the PCB 110 and the transmission lines on the FPC 130, an effect of impedance mismatching of used transmission lines in contradistinction to an operating frequency is not serious. However, the liquid crystal display device using the COG manner additionally includes transmission lines called “LOG,” and impedance mismatching thereof becomes has been raised as a serious problem.

Especially, when the COG manner is employed in the liquid crystal display device as shown in FIG. 1, without any changes, data transmitted to the source driver ICs is distorted by the aforementioned mismatching, so that the frequency characteristic is deteriorated. Therefore, when the COG manner is used, signal transmission/reception between a timing controller and source driver ICs must be performed in a point-to-point manner, instead of the conventional multi-drop manner.

FIG. 3 is a view illustrating a conventional liquid crystal display device using a COG manner and a point-to-point manner.

Referring to FIG. 3, the COG type liquid crystal display device 300 includes a PCB 310, a glass substrate 320, and an FPC 330.

On the PCB 310, a timing controller 311 is mounted. A pair of differential signals output from the timing controller 311 is transmitted to a plurality of source driver ICs 322 through transmission lines 313 in the point-to-point manner.

On the glass substrate 320, not only a liquid crystal panel 321, but also a plurality of source driver ICs 322 and a plurality of gate driver ICs 323 for controlling the operation of the liquid crystal panel 321 are mounted in the COG manner.

The respective source driver ICs 322 include at least one termination resistor 325. Each source driver IC 322 converts received differential signals into corresponding differential voltage signals, and drives the liquid crystal panel 321 through the use of the converted differential voltage signals.

The FPC is a medium for electrical connection between the PCB 310 and the glass substrate 320. The transmission lines LOG formed on the glass substrate 320 electrically connect the FPC 330 to the plurality of source driver ICs 322.

FIG. 4 is a view showing an equivalent model of the conventional liquid crystal display device shown in FIG. 3.

Referring to FIG. 4, the equivalent model of the conventional COG type liquid crystal display device includes a transmission unit 311, transmission lines 313 on a PCB, an FPC 330, an LOG 324, a termination resistor 325, and a reception unit 322.

The equivalent model 311 of the transmission unit represents a transmitter Tx corresponding to the timing controller. It is assumed that the transmission lines 313 on the PCB and the FPC 330 are ideal. In addition, since the transmission lines implemented on the PCB and FPC have resistance components enough to ignore the impedances and capacitance thereof, as compared with the transmission lines LOG 324 implemented on top of the liquid crystal panel 321, the transmission lines implemented on the PCB and FPC are simply expressed only with signal lines.

The equivalent model 324 of the LOG is defined as transmission lines LOG which are implemented on top of the glass substrate 320, and electrically couple the FPC 330 and the source driver ICs 322 to each other. The equivalent model 322 of the reception unit is defined as a receiver Rx corresponding to the source driver ICs.

The electrical characteristics of passive elements included in the equivalent models, the values of the elements, and a connection relationship between the elements can be easily understood by those skilled in the art, so a detailed description thereof will be omitted.

When the aforementioned liquid crystal display device, to which the COG manner and the point-to-point manner are applied, is implemented, the timing controller supplies point-to-point low-voltage differential signals to the source driver ICs.

In this case, according to the conventional technology, a termination resistor has been designed to be located at the nearest possible position to the reception unit in order to minimize loss of voltage induced between both terminals of the termination resistor, and such a method is applied to the liquid crystal display device using the COG manner without any changes, so that a resistance element is implemented generally on the reception terminals in source driver ICs.

In this case, in signal transmission/reception between a timing controller and source driver ICs, a factor exerting the largest influence on the operating speed is the impedance value of transmission lines LOG on a glass substrate. Especially, in a COG type liquid crystal display device, LOG has a very high impedance value of several tens to several hundreds of ohms, so that, when a termination resistor is included only in the source driver ICs, like in the conventional transmission scheme, it is difficult to achieve impedance matching of the input terminals of the source driver ICs, thereby deteriorating the frequency characteristic.

In the conventional point-to-point liquid crystal display device using the COG manner, since the operating frequency is not high, impedance mismatching at transmission lines does not matter. However, when the COG manner is used in a large-sized liquid crystal display device having high resolution and high quality, a very high operating frequency is required, and thus impedance matching at transmission lines is required, so that the conventional configuration including termination resistors at the reception terminals in source driver ICs is not suitable to implement a high-resolution high-quality image in a COG type liquid crystal display device.

### SUMMARY OF THE INVENTION

Accordingly, the present invention has been made in an effort to solve the problems occurring in the related art, and an object of the present invention is to provide a COG type liquid crystal display device using COG and point-to-point manners, which minimizes an reflected wave from an input terminal of a source driver IC by providing an impedance matching resistor on a front terminal of LOG or on an output terminal of a timing controller, thereby preventing signal distortion, and thus making it possible to express a high-resolution image.

In order to achieve the above object, according to one aspect of the present invention, there is provided a chip-on-glass (COG) type liquid crystal display device including: a PCB on which a timing controller is mounted; and a glass substrate on which a liquid crystal panel and at least one source driver IC are mounted in a chip-on-glass manner, wherein at least one pair of differential signals output from the timing controller are transmitted to the at least one source driver IC through a transmission line in a point-to-point manner, and an impedance matching resistor is provided on an output terminal of the timing controller.

According to another aspect of the present invention, there is provided a chip-on-glass (COG) type liquid crystal display device including: a PCB on which a timing controller is mounted; and a glass substrate on which a liquid crystal panel and at least one source driver IC are mounted in a chip-on-glass manner, wherein at least one pair of differential signals output from the timing controller are transmitted to the at least one source driver IC through a transmission line in a point-to-point manner, and an impedance matching resistor is provided at a front terminal of an LOG.

### BRIEF DESCRIPTION OF THE DRAWINGS

The above objects, and other features and advantages of the present invention will become more apparent after a reading of the following detailed description taken in conjunction with the drawings, in which:

FIG. 1 is a view showing an example of a conventional liquid crystal display device;

FIG. 2 is a view showing an equivalent model of the conventional liquid crystal display device shown in FIG. 1;

FIG. 3 is a view illustrating a conventional liquid crystal display device using a COG manner and a point-to-point manner;

FIG. 4 is a view showing an equivalent model of the conventional liquid crystal display device shown in FIG. 3;

FIG. 5 is a view illustrating a chip-on-glass (COG) type liquid crystal display device according to a first embodiment of the present invention;

FIG. 6 is a view showing an equivalent model of the COG type liquid crystal display device shown in FIG. 5 according to the first embodiment of the present invention;

FIG. 7 is a view showing the result of a computer simulation of the waveforms of differential signals detected in a source driver IC of the COG type liquid crystal display device of FIG. 5 according to the first embodiment of the present invention;

FIG. 8 is a view illustrating a COG type liquid crystal display device according to a second embodiment of the present invention;

FIG. 9 is a view showing an equivalent model of the COG type liquid crystal display device of FIG. 8 according to the second embodiment of the present invention;

FIG. 10 is a view showing the result of a computer simulation of the waveforms of differential signals detected in a source driver IC of the COG type liquid crystal display device of FIG. 8 according to the second embodiment of the present invention;

FIG. 11 is a view illustrating a COG type liquid crystal display device according to a third embodiment of the present invention; and

FIG. 12 is a view showing an equivalent model of the COG type liquid crystal display device shown in FIG. 11 according to the third embodiment of the present invention.

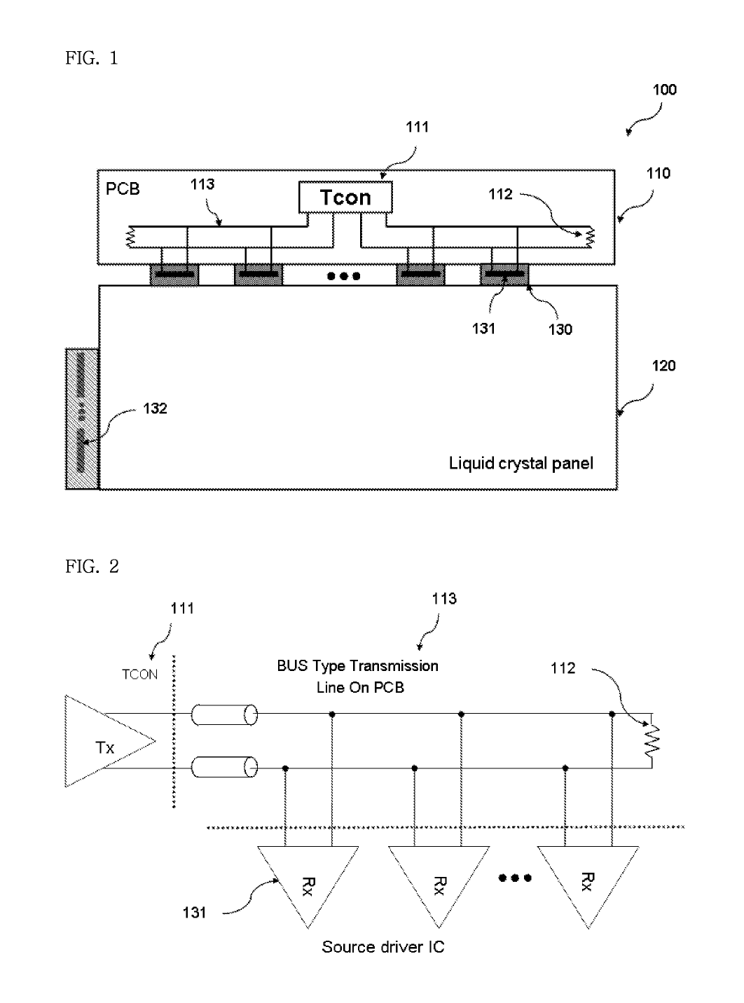

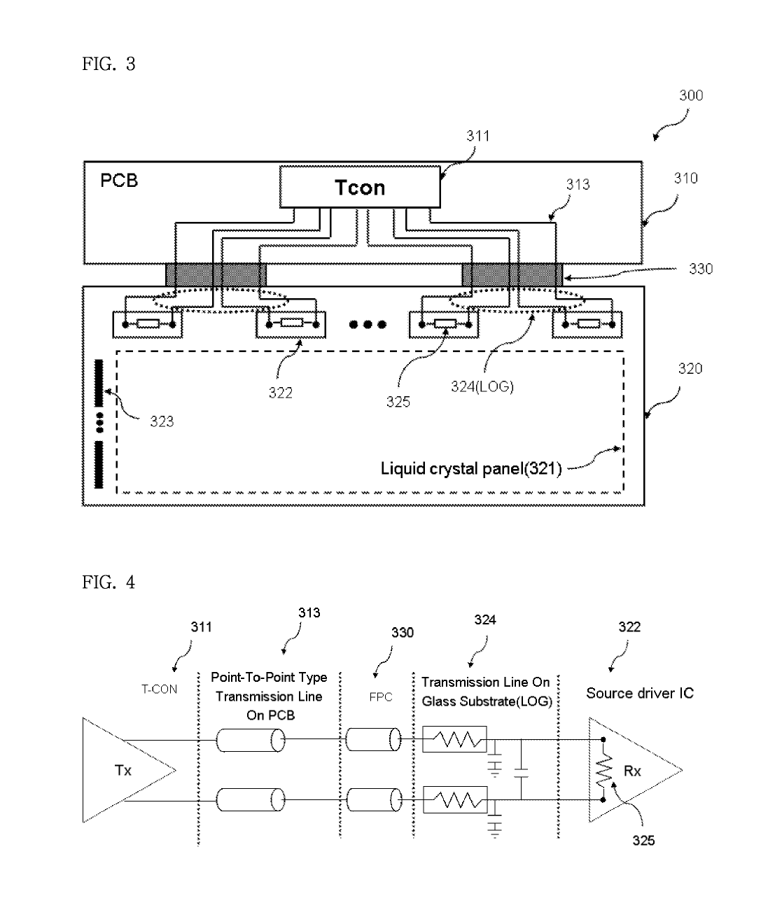

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

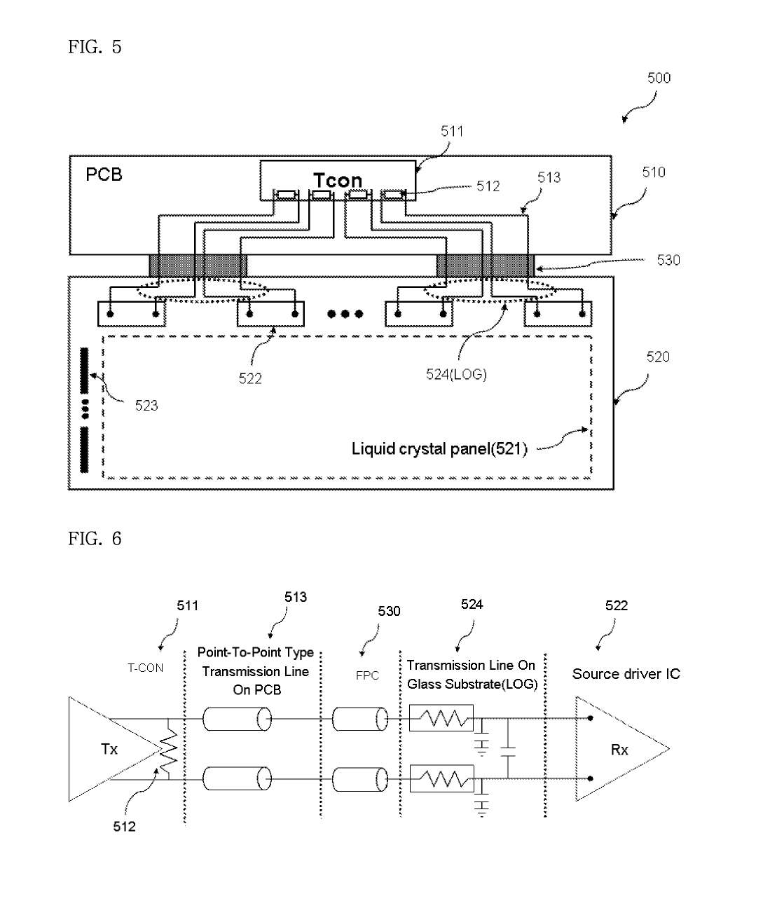

FIG. 5 is a view illustrating a chip-on-glass (COG) type liquid crystal display device according to a first embodiment of the present invention.

As shown in FIG. 5, the COG type liquid crystal display device 500 according to the first embodiment of the present invention includes a printed circuit board (PCB) 510, a glass substrate 520, and a flexible printed circuit (FPC) 530.

The PCB 510 includes a timing controller 511. Also, on the PCB 510, transmission lines 513 are provided to transmit a pair of differential signals output from the timing controller 511 to the glass substrate. The timing controller 511 includes an impedance matching resistor 512 for impedance matching.

In addition, a liquid crystal panel 521, a plurality of source driver ICs 522, and a plurality of gate driver ICs 523 are mounted on the glass substrate 520 in a chip-one-glass manner.

The FPC 530 is a medium for electrical connection between the PCB 510 and the glass substrate 520. The characteristics and functions of the FPC 530 have been well known in the art, so a detailed description thereof will be omitted.

A pair of differential signals output from the timing controller 511 is transmitted to the plurality of source driver ICs 522 in a point-to-point manner. The plurality of source driver ICs 522 drives the liquid crystal panel 521 through the use of the received differential signals. In this case, the at least one pair of differential signals may include a signal pair corresponding to image data, a clock signal pair, or a signal pair corresponding to image data and a clock signal pair.

The characteristic impedance Z_{PCB} of a PCB transmission is expressed as Equation 1 below, and a ratio of reflected wave, i.e. a reflection coefficient Γ, between a timing controller and a PCB is expressed as Equation 2 below.

$$\begin{matrix}{Z}_{PCB} = \sqrt{\frac{{L}_{PCB}}{{C}_{PCB}}} & ( 1 ) \\ Γ = \frac{{Z}_{PCB} - {R}_{TCON}}{{Z}_{PCB} + {R}_{TCON}} & ( 2 )\end{matrix}$$

Here, C_{PCB} and L_{PCB} represent the capacitance and reactance, respectively, of the PCB transmission lines.

In this case, in order to transmit high-speed data, it is necessary to minimize the reflected wave between the timing controller and the PCB. That is to say, the reflection coefficient between the timing controller and PCB must be zero. To make the reflection coefficient zero, the characteristic impedance Z_{PCB} of the PCB transmission lines must be equal to the internal resistance R_{TCON} of the timing controller. When the reflection coefficient between a timing controller and a PCB is zero, it called “impedance matching.”

As described above, according to the COG type liquid crystal display device 500 based on the first embodiment of the present invention, the impedance matching resistor 512 is implemented on the output terminal of the timing controller 511, thereby matching the impedance seen at the timing controller 511 with the impedance seen at the PCB 510.

When impedance matching is achieved as described above, the reflected wave of transmitted differential signals can be minimized, so that it is possible to transmit a high-quality signal and to implement a high-resolution image. In addition, there is an advantage in that, since the impedance matching resistor is included on the inside of the timing controller 511, it is possible to reduce the unit cost of manufacturing PCBs.

FIG. 5 shows a case where the transmission lines LOG implemented on the glass substrate 520 are all directly coupled to the source driver ICs 522.

However, only a part of the transmission lines LOG implemented on the glass substrate 520 may be directly coupled to a part of the source driver ICs, while the other transmission lines are implemented in such a manner as to bypass said part of the source driver ICs coupled with said part of the transmission lines and to be coupled to the other source driver ICs.

FIG. 6 is a view showing an equivalent model of the COG type liquid crystal display device shown in FIG. 5 according to the first embodiment of the present invention.

Referring to FIG. 6, the equivalent model of the COG type liquid crystal display device according to the first embodiment of the present invention includes a transmission unit 511, the impedance matching resistor 512, the transmission lines 513 on the PCB, the FPC 530, an LOG 524, and a reception unit 522.

The equivalent model 511 of the transmission unit represents a transmitter Tx corresponding to the timing controller, and the impedance matching resistor 512 is formed at the output terminal of the timing controller.

It is assumed that the transmission lines 513 on the PCB and the transmission lines on the FPC 530 are ideal. In addition, since the transmission lines 513 on the PCB and the transmission lines 530 on the FPC have resistance components enough to ignore the impedances thereof, as compared with the transmission lines LOG 524 implemented on top of the glass substrate 520, the transmission lines on the PCB and FPC are simply expressed only with signal lines.

The equivalent model 524 of the LOG is defined as transmission lines which are implemented on top of the glass substrate 520, and electrically couple the source driver ICs 522 and the transmission lines of the FPC 530 to each other. The equivalent model 522 of the reception unit is defined as a receiver Rx corresponding to the source driver ICs.

The electrical characteristics of passive elements included in the equivalent models, the values of the elements, and a connection relationship between the elements can be easily understood by those skilled in the art, so a detailed description thereof will be omitted.

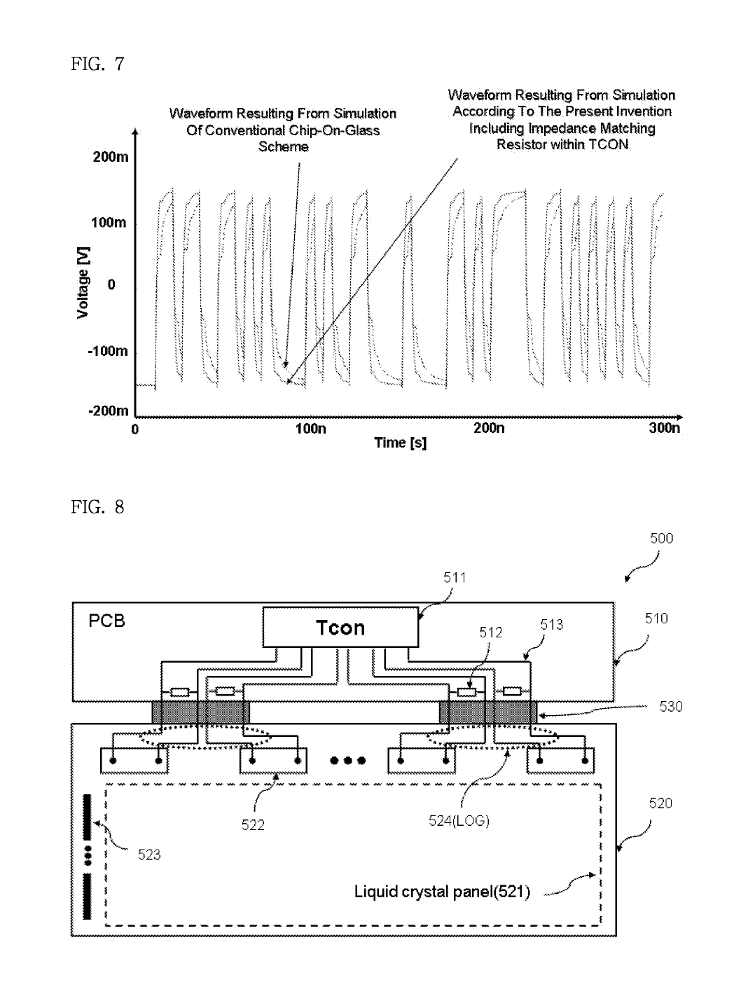

FIG. 7 is a view showing the result of a computer simulation of the waveforms of differential signals detected in a source driver IC of the COG type liquid crystal display device of FIG. 5 according to the first embodiment of the present invention.

Referring to FIG. 7, it can be understood that a voltage difference between differential signals detected in a source driver IC of the COG type liquid crystal display device according to the first embodiment of the present invention is larger than that in the conventional liquid crystal display device. A larger voltage difference means that the logical values of signals can be determined easier, which means that signal waveforms have a high quality.

That is to say, since the COG type liquid crystal display device according to the first embodiment of the present invention can operate at a high speed, the COG type liquid crystal display device according to the first embodiment of the present invention can implement a high-resolution image quality, differently from the conventional COG type liquid crystal display device.

FIG. 8 is a view illustrating a COG type liquid crystal display device according to a second embodiment of the present invention.

The COG type liquid crystal display device 500 shown in FIG. 8 according to the second embodiment of the present invention is the same as the COG type liquid crystal display device 500 shown in FIG. 5 according to the first embodiment of the present invention, except that the impedance matching resistor 512 is not provided on the output terminal of the timing controller 511, but is provided at the terminals of the transmission lines 513 on the PCB 510.

In order to transmit high-speed data, it is necessary to achieve impedance matching between PCB transmission lines and transmission lines on a glass substrate and an FPC, similarly between the timing controller and the PCB transmission lines.

Equation 3 expresses a reflection coefficient between the PCB transmission lines and the transmission lines on the glass substrate and FPC.

$$Γ = \frac{{Z}_{PCB} - ( {Z}_{FPC} + {R}_{LOG} )}{{Z}_{PCB} + ( {Z}_{FPC} + {R}_{LOG} )} \qquad ( 3 )$$

In this case, in order for the reflection coefficient between the PCB transmission lines and the transmission lines on the glass substrate and FPC to be zero, the characteristic impedance Z_{PCB} of the PCB transmission lines must be equal to a sum “Z_{FPC}+R_{LOG}” of the impedances of transmission lines on the glass substrate and FPC.

As shown in FIG. 8, according to the COG type liquid crystal display device 500 based on the second embodiment of the present invention, the impedance matching resistor 512 is implemented on the terminals of the transmission lines 513 on the PCB 510, thereby matching the impedance seen at the PCB 510 with the impedance seen at the glass substrate 520 and FPC 530.

When impedance matching is achieved as described above, the reflected wave of transmitted differential signals can be minimized, so that it is possible to transmit a high-quality signal and to implement a high-resolution image.

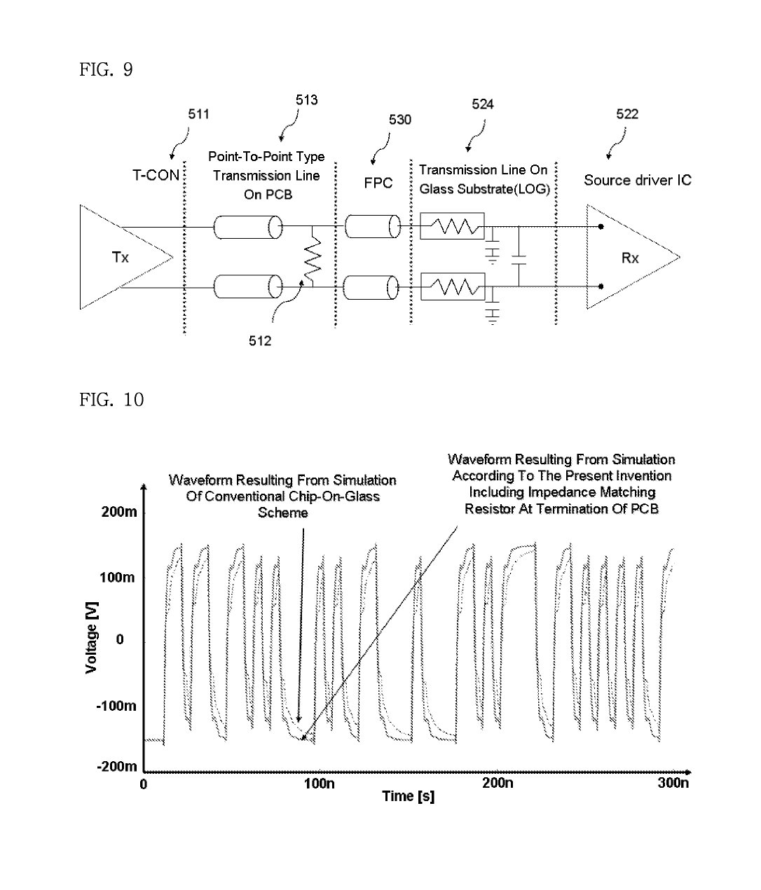

FIG. 9 is a view showing an equivalent model of the COG type liquid crystal display device of FIG. 8 according to the second embodiment of the present invention.

The equivalent model of the COG type liquid crystal display device shown in FIG. 9 according to the second embodiment of the present invention also is the same as that shown in FIG. 6, except that the impedance matching resistor 512 is not provided on the output terminal of the timing controller 511, but is provided at the terminals of the transmission lines 513 on the PCB 510, so a detailed description thereof will be omitted.

FIG. 10 is a view showing the result of a computer simulation of the waveforms of differential signals detected in a source driver IC of the COG type liquid crystal display device of FIG. 8 according to the second embodiment of the present invention.

Referring to FIG. 10, it can be understood that a voltage difference between differential signals having passed through the COG type liquid crystal display device according to the second embodiment of the present invention is larger than that having passed through the conventional COG type liquid crystal display device, similar to that shown in FIG. 7, so that signal waveforms have a higher quality.

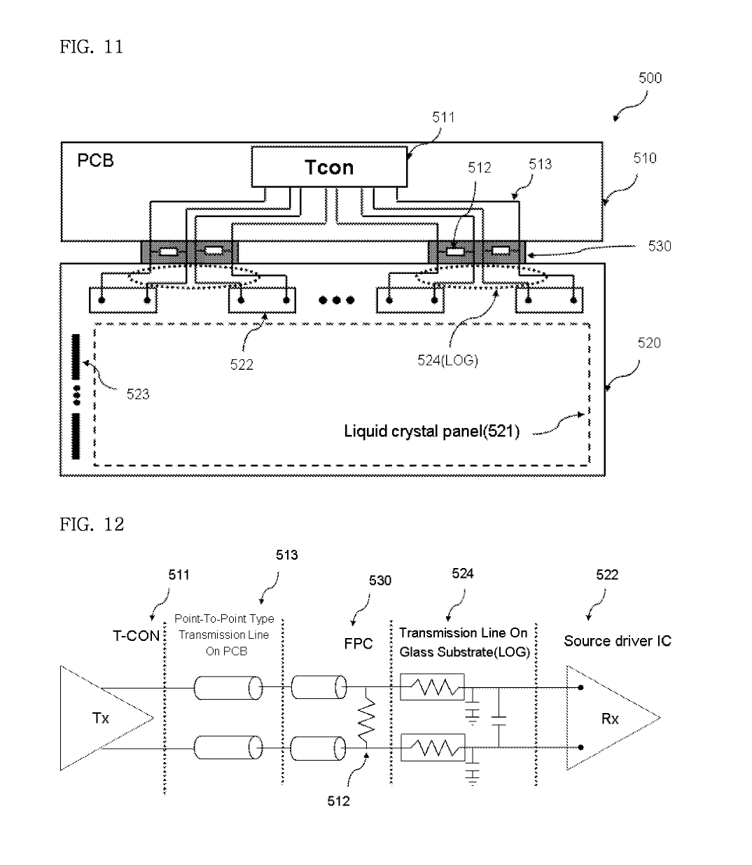

FIG. 11 is a view illustrating a COG type liquid crystal display device according to a third embodiment of the present invention.

The COG type liquid crystal display device 500 shown in FIG. 11 according to the third embodiment of the present invention is the same as the COG type liquid crystal display device 500 shown in FIG. 8 according to the first embodiment of the present invention, except that the impedance matching resistor 512 is not provided at the terminals of the transmission lines 513 on the PCB 510, but is provided on the FPC 530.

Equation 4 expresses a reflection coefficient between the PCB transmission lines and the transmission lines on the glass substrate.

$$Γ = \frac{{Z}_{PCB} - {R}_{LOG}}{{Z}_{PCB} + {R}_{LOG}} \qquad ( 4 )$$

Here, it is assumed that the impedance Z_{PCB} of the PCB and the impedance Z_{FPC} of the FPC have the same value to be matched with each other. In this case, in order for the reflection coefficient between the PCB transmission lines and the transmission lines on the glass substrate to be zero, the characteristic impedance Z_{PCB} or Z_{FPC} of the PCB or FPC transmission lines must be equal to the impedance R_{LOG} of the transmission lines on the glass substrate.

As shown in FIG. 10, according to the COG type liquid crystal display device 500 based on the third embodiment of the present invention, the impedance matching resistor 512 is implemented on the FPC 530, thereby matching the impedance seen at the PCB 510 or FPC 530 with the impedance seen at the glass substrate 520.

When impedance matching is achieved as described above, the reflected wave of transmitted differential signals can be minimized, so that it is possible to transmit a high-quality signal and to implement a high-resolution image.

FIG. 12 is a view showing an equivalent model of the COG type liquid crystal display device shown in FIG. 11 according to the third embodiment of the present invention.

The equivalent model of the COG type liquid crystal display device shown in FIG. 12 according to the third embodiment of the present invention also is the same as that shown in FIG. 9, except that the impedance matching resistor 512 is not provided at the terminals of the transmission lines 513 on the PCB 510, but is provided on the FPC 530, so a detailed description thereof will be omitted.

The result of a computer simulation of the waveforms of differential signals detected in a source driver IC of the COG type liquid crystal display device of FIG. 11 according to the third embodiment of the present invention is very similar to the result of the computer simulation shown in FIG. 10 according to the second embodiment of the present invention, so a description thereof will be omitted.

As is apparent from the above description, the present invention provides a COG type liquid crystal display device which includes an impedance matching resistor disposed either on the inside of a timing controller or at the terminals of transmission lines implemented on a PCB so as to minimize an influence of transmission lines formed on a glass substrate, thereby having an advantage in that a high-speed high-quality signal can be transmitted between the timing controller and source driver ICs.

Especially, according to the COG type liquid crystal display device based on the present invention, chip-on-glass technology, which has been applied mostly only to small or medium-sized liquid crystal display devices, can be used even for large-sized liquid crystal display devices, so that it is possible to implement a large-sized liquid crystal display device having a slim and lightweight design and to reduce the fabrication cost.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A chip-on-glass (COG) type liquid crystal display device comprising:
a PCB on which a timing controller is mounted;
a glass substrate on which a liquid crystal panel and at least one source driver IC are mounted in a chip-on-glass manner; and
a flexible printed circuit (FPC) configured to form a transmission path for at least one pair of differential signals between the PCB and the glass substrate,
wherein the differential signals output from the timing controller are transmitted to the at least one source driver IC through a transmission line in a point-to-point manner, and
wherein an impedance matching resistor is provided on an output terminal of the timing controller.

2. A chip-on-glass (COG) type liquid crystal display device comprising:
a PCB on which a timing controller is mounted;
a glass substrate on which a liquid crystal panel and at least one source driver IC are mounted in a chip-on-glass manner; and
a flexible printed circuit (FPC) configured to form a transmission path for at least one pair of differential signals between the PCB and the glass substrate,
wherein the differential signals output from the timing controller are transmitted to the at least one source driver IC through a transmission line in a point-to-point manner, and
wherein an impedance matching resistor is provided at a terminal of the transmission line formed on the PCB.

3. A chip-on-glass (COG) type liquid crystal display device comprising:
a PCB on which a timing controller is mounted;
a glass substrate on which a liquid crystal panel and at least one source driver IC are mounted in a chip-on-glass manner; and
a flexible printed circuit (FPC) configured to form a transmission path for at least one pair of differential signals between the PCB and the glass substrate,
wherein the differential signals output from the timing controller are transmitted to the at least one source driver IC through a transmission line in a point-to-point manner, and
wherein an impedance matching resistor is provided on the FPC positioned between the PCB and the glass substrate.

4. The COG type liquid crystal display device according to claim 1, wherein the transmission line formed on the glass substrate is coupled to the source driver IC in a line-on-glass (LOG) manner.

5. The COG type liquid crystal display device according to claim 4,
wherein a part of the transmission line formed on the glass substrate is coupled directly to a part of the at least one source driver IC, and
wherein a remaining transmission line is coupled to a remaining part of the at least one source driver IC while bypassing said part of the at least one source driver IC coupled with said part of the transmission line.

6. The COG type liquid crystal display device according to claim 4, wherein the at least one pair of differential signals comprises a signal pair corresponding image data and a clock signal pair, a signal pair corresponding image data or a clock signal pair, or a signal pair corresponding to image data in which a clock signal is embedded.

7. The COG type liquid crystal display device according to claim 4, wherein the glass substrate further comprises at least one gate driver IC configured to drive the liquid crystal panel.

8. The COG type liquid crystal display device according to claim 2, wherein the transmission line formed on the glass substrate is coupled to the source driver IC in a line-on-glass (LOG) manner.

9. The COG type liquid crystal display device according to claim 8,
wherein a part of the transmission line formed on the glass substrate is coupled directly to a part of the at least one source driver IC, and
wherein a remaining transmission line is coupled to a remaining part of the at least one source driver IC while bypassing said part of the at least one source driver IC coupled with said part of the transmission line.

10. The COG type liquid crystal display device according to claim 8, wherein the at least one pair of differential signals comprises a signal pair corresponding image data and a clock signal pair, a signal pair corresponding image data or a clock signal pair, or a signal pair corresponding to image data in which a clock signal is embedded.

11. The COG type liquid crystal display device according to claim 8, wherein the glass substrate further comprises at least one gate driver IC configured to drive the liquid crystal panel.

12. The COG type liquid crystal display device according to claim 3, wherein the transmission line formed on the glass substrate is coupled to the source driver IC in a line-on-glass (LOG) manner.

13. The COG type liquid crystal display device according to claim 12,
wherein a part of the transmission line formed on the glass substrate is coupled directly to a part of the at least one source driver IC, and
wherein a remaining transmission line is coupled to a remaining part of the at least one source driver IC while bypassing said part of the at least one source driver IC coupled with said part of the transmission line.

14. The COG type liquid crystal display device according to claim 12, wherein the at least one pair of differential signals comprises a signal pair corresponding image data and a clock signal pair, a signal pair corresponding image data or a clock signal pair, or a signal pair corresponding to image data in which a clock signal is embedded.

15. The COG type liquid crystal display device according to claim 12, wherein the glass substrate further comprises at least one gate driver IC configured to drive the liquid crystal panel.
